(19) United States
(12) Patent Application Publication
(10) Pub. No.: US 2015/0134445 A1
(43) Pub. Date: May 14, 2015

(54) INTELLIGENT MATCHING OF ADVERTISEMENT TO CONTENT

(71) Applicant: Kiosked OY, Espoo (FI)

(72) Inventors: Antti Pasila, Helsinki (FI); Lars-Michael Paqvalén, Espoo (FI); Marcus Räder, Helsinki (FI); Vladimir Grigor, Espoo (FI)

(21) Appl. No.: 14/493,572

(22) Filed: Sep. 23, 2014

Related U.S. Application Data
(60) Provisional application No. 61/881,017, filed on Sep. 23, 2013.

(51) Int. Cl. G06Q 30/02; G06F 17/30

(52) U.S. Cl. CPC G06Q 30/0269; G06F 17/30876; G06Q 30/0246; G06Q 30/0277
USPC 705/14.45; 705/14.66

(57) ABSTRACT

A system and method for presenting advertising is implemented by an advertisement server having a database of products organized in a hierarchy of themes, an interface module web server configured to analyze content of a web page to identify one or more themes of the web page, and a user terminal configured to access the web page and configured for presenting advertisements from the database that have themes matching the web page themes.

### TECHNICAL FIELD

The general area of the disclosure is on-line advertisement. The present disclosure generally relates to a system and a method for serving relevant product specific advertisements.

### BACKGROUND

Shopping and advertising have been a big topic in the Internet industry and growing at a very fast pace. An estimate suggests that worldwide advertising revenue is set to reach $11.4 billion in 2013, up from $9.6 billion in 2012. There are many different methods of delivering advertisements in combination with web pages, games, applications, web applications, and software. Internet based businesses rely on advertisements to promote their business according to their marketing plans. Advertisements play an important role in generating revenue for mobile content and software developers.

Conventionally, advertisements appear on websites, games, software application or other media, such as content displayed in web browsers. The advertisements themselves are selected and served by automated systems based on the content displayed to the user. Presently, advertisers are able to reach a large audience. However, they are frequently dissatisfied with the return on their advertisement investment. As the advertisements are oftentimes overly general or specific, most end-users are bombarded with irrelevant and sometimes annoying advertisements that are of little value. An end-user will generally not be interested in the advertised service or product if it is of little or no relevance to the end-user's needs. However, tailoring relevant ads to each user can be very expensive. Some presently available advertisement systems provide advertisements to web sites based on keywords in the web site. This can lead to situations where keywords are associated wrongly with a product which is not relevant at all to the actual substance of the content. For example a web site might have text “Madrid”. This could trigger an advertisement related to the city of Madrid or to a football team referred to as Madrid.

Hence, there exists a need for a system and user interface that facilitates intelligent matching of advertisements that solves the problem of content-to-product matching while displaying the advertisement and that overcomes the above-mentioned limitations of existing of methods of displaying advertisements.

### BRIEF SUMMARY

The present disclosure provides a system and method enabling on-line advertisement. The present disclosure generally relates to a system and a method for serving relevant product specific advertisements.

In one aspect, embodiments of the present disclosure provide a system for displaying an advertisement by content-to-product matching based on themes within topics of information and optionally includes a web server, advertisement server, user terminal, product database, filtering module, theme pools, and an interface module. In other aspects of the present disclosure, the advertisements displayed on a device are adapted according to the device characteristics such as model, type, screen size, memory capabilities or user settings.

In accordance with one or more embodiments of the present disclosure, the user terminal can be a laptop, personal computer, desktop computer, smart phone, web tablet, one or more wireless devices including, although are not limited to, smart phones, Mobile Internet Devices (MID), wireless-enabled tablet computers, Ultra-Mobile Personal Computers (UMPC), phablets, tablet computers, Personal Digital Assistants (PDA), web pads, cellular phones, an iPhone®, or any device with the capability to access content such as web content over an Internet connection.

According to at least one embodiment disclosed herein, a method of providing on line advertising includes storing a database of products in an advertisement server, the products organized in a hierarchy of themes, while using a terminal to access a web page, analyzing content of the web page to identify one or more themes of the web page, and using an interface module of the advertisement server to retrieve advertisements from the database for products that have themes matching the web page themes.

In accordance with another embodiment of the present disclosure, a system for presenting advertising includes an advertisement server having a database of products organized in a hierarchy of themes, an interface module web server configured to analyze content of a web page to identify one or more themes of the web page, and a user terminal configured to access the web page and configured for presenting advertisements from the database that have themes matching the web page themes.

In accordance with yet another embodiment of the present disclosure, a method of providing on line advertising includes storing a database of products in an advertisement server, the products organized in a hierarchy of topics and themes within each topic, wherein the products are assigned themes according sales resulting from a product and theme combination, using a feedback loop to determine a profitability index associated with each product, while using a terminal to access a web page, analyzing content of the web page to identify a topic and theme of the web page, and using an interface module of the advertisement server to retrieve advertisements from the database for products that have topics and themes matching the web page topics and themes and that meet a profitability index threshold.

Optionally, the present system and method may also be implemented as a computer-readable/useable medium that includes computer program code to enable one or more computer devices to implement each of the various process steps in a method in accordance with the disclosed embodiments.

Additional aspects, advantages, features and objects of the present disclosure will be made apparent from the drawings and the detailed description of the illustrative embodiments.

It will be appreciated that features of the disclosure are susceptible to being combined in various combinations or further improvements without departing from the scope of the disclosure and this provisional application.

### DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the disclosure is not limited to specific methods and instrumentalities disclosed herein. Moreover, those in the art will understand that the drawings are not to scale. Wherever possible, like elements have been indicated by identical numbers.

FIG. 1 shows a high level system architecture related to embodiments of the disclosure.

FIG. 2 shows a simplified flow chart on how to select a product to be advertised.

FIG. 3 shows an example use case of intelligent matching of web site content to advertisement.

FIG. 4 shows an example of a user interface for managing themes.

FIG. 5 shows an example of a user interface for managing themes and related products.

FIG. 6 shows a block diagram of an exemplary computing apparatus that may be used to practice aspects of the present disclosure.

### DETAILED DESCRIPTION

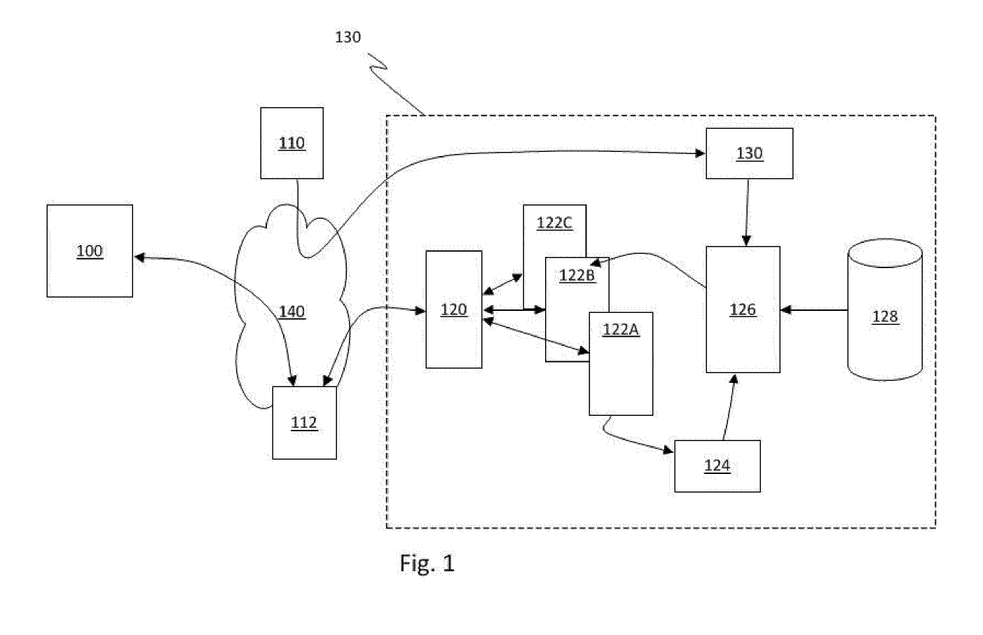

Referring now to the drawings, particularly by their reference numbers, FIG. 1, shows an exemplary high level architecture related to embodiments of the disclosure. A user with a user terminal 100 accesses a web server 112, via internet connection 140, running a web site of a publisher. Non limiting examples of the publisher may include news web sites such as CNN.com®, BBC®, Times®, Guardian®, or any other website providing textual, image, video, audio, or any other content to users over a web interface. According to an exemplary embodiment, the content is accessed with a web browser.

According to the disclosed embodiments the web server 112 may be configured to obtain certain information from an advertisement service running on an advertisement computer system or server system 130. As an example, the web site content provided by the web server 112 may be implemented in code such as HyperText Markup Language (HTML), or any suitable code and may include a code snippet such as a Java® script. As the Java® script is executed in the user terminal 100 the user terminal connects to computer system 130 to fetch information such as advertisements. Alternatively, server 112 can pre fetch information from the advertisement server 130 and include that in the web site content code depending on the implementation.

The advertisement server system 130 can be implemented as a single server or a set of servers running in a single location, the servers can be arranged spatially in different locations, or the servers can be organized, run from, or run as, a cloud service. The advertisement server system 130 generally includes processors, memories, hard disks, databases, communication interfaces, and other hardware and software.

In an example embodiment, the advertisement server 130 includes a product database 128. The product database 128 can have an arbitrary number of products that can be advertised to consumers using the terminal 100. There can be, for example, thousands or millions of different products in the database 128. There might be products which are similar in nature, such as footballs used in the game of football from different manufactures with different sizes and colors, differently branded, for example, where different versions of footballs represent different teams. Each of the products in the database may include information about the product, for example, an image or images of the product and information related to where and how to get the product, including for example, a link to a vendor, web shop, purchase application to purchase products, or other information or applications. The information may include one or more advertisements for the product. A product may refer to a physical product such as a football, shoe, car, or other tangible product, or to a non-physical product such as an application, a download, software, media, or a service such as a cleaning service or taxi service, or other non-tangible product.

A filtering module 126 is used to extract products from the database 128 to a set of pools 122 such as 122A, 122B, and 122C. There can be an arbitrary number of pools 122. Each of the pools may have a set of products related to a certain theme on the advertisement server 130. The product theme for each pool can be configured on the advertisement server 130 by each publisher, for example, via a web interface using a computer 110 with a web browser, or the product theme can be generic for all publishers. In one or more embodiments, the product theme can be set automatically or manually. In general the product theme may be used to organize sub sets of products from database 128 to be directed to each of the pools. Similar products can belong to one or more pools 122 at the same time. For example, some of the products such as a sports magazine can belong to a pool related to a product theme “sport” and to pools related to product themes “football”, “ice hockey”, “tennis” or, for example, to a pool designated “magazines”. Filtering module 126, can be configured to organize the products among the different pools manually or can be configured to organize the products by a feedback loop module 124. Feedback loop module 124 may determine a utilization measure of products in one or more of the pools 122A, 122B, 122C. For example, feedback loop module 124 may calculate a number sales of a product, for each theme assigned to the product, to determine the effectiveness of each theme assignment. Thus, themes may be assigned according to sales resulting from the product and theme combination. The product may be assigned to themes that meet or exceed a certain threshold of sales. Feedback loop module 124 may also be utilized to calculate profitability measures for products as described below.

An interface module 120 may include or be configured to execute a rule set for each enquiry originating from a user terminal 100 while accessing content in server 112 of the publisher. The rule sets may direct an enquiry for advertisement content to a relevant pool. An exemplary rule set could include stating that the content in an accessed web site is based on the themes “sport” and “tennis” with instructions that “tennis” is a subcategory of “sport”. The stated rule set would direct the enquiry first to the pool having the product theme “tennis”. If the pool includes feasible advertisements, one or more advertisements may be provided to user terminal 100 either directly or via server 112. If the product theme pool “tennis” does not have feasible advertisements, the interface module 120 could then access a pool having products related to the parent theme of the accessed web site, for example, the theme “sports”. If said “sports” pool includes at least one feasible advertisement, one or more advertisements are provided to user terminal 100 either directly or via server 112. If the pool defined by the theme “sports” does not include feasible advertisement content, a another parent pool based on the rule sets may be selected. If there is no parent pool defined i.e. said “sports” is the top pool based on the rule set, then either no advertisement may be provided or some other advertisement may be selected. For example, an advertisement can be selected randomly or from a pool having the theme “generic,” to provide feasible generic content.

According to the disclosed embodiments, the rule sets can be set by a publisher of the accessed web site. Additionally rule sets can be set automatically, by an advertisement service provider, by a third party or can be configured by consumers.

The advertisement content may include any manner of digital content, whether audio, video, graphical content or text, in any structure, format or medium. The content may include or incorporate for example, e-books, articles, selections of e-books or articles, compilations of works, dynamically generated document summaries, data feeds such as RSS or TWITTER™, FACEBOOK™, feeds, blogs or blog portions, web excerpts, search results, or any suitable advertising content.

The user terminal 100 can be a laptop, personal computer, desktop computer, smart phone, web tablet, one or more wireless devices including, although are not limited to, smart phones, Mobile Internet Devices (MID), wireless-enabled tablet computers, Ultra-Mobile Personal Computers (UMPC), phablets, tablet computers, Personal Digital Assistants (PDA), web pads, cellular phones, an iPhone®, or any device with a capability to access content such as web content over an Internet connection 140.

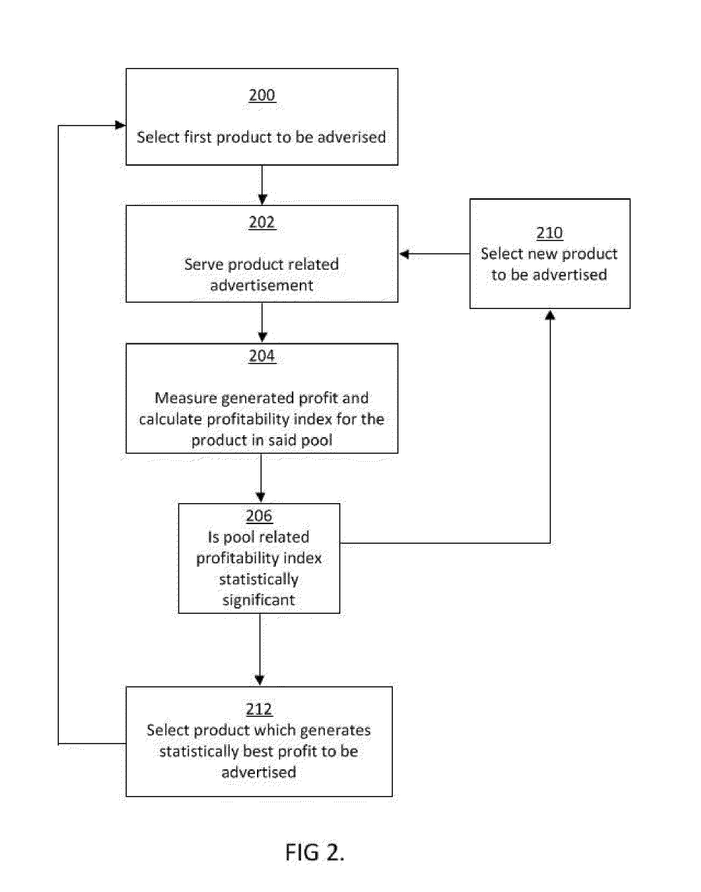

FIG. 2 shows an exemplary flow chart on how to select a product to be advertised from a pool 122. In this example, products in a pool are all assigned a profitability index of zero. In step 200 a first product is selected to be advertised. The selection can be random, round robin i.e. selecting first in the list first, then next in the list or any other selection process. The product advertisement may be served to the consumer through user terminal 100 as part the web site running in server 112, as shown in step 202. In some examples, the advertisement may be part of, embedded in, overlaid on, or shown as a banner on the web site. A user may or may not take action related to the advertisement. The resulting profit impact of the product may be measured in step 204 and may optionally be reported to the advertisement service 130. Profit impact may depend on business rules, settings, contracts related to the advertisement or product or any suitable criteria. For example, profit impact can be based on per impression, per click or per action. Per action can refer to actual sales resulting from advertisements such as purchasing of the product that is/was advertised. The measured profit impact may be used to calculate a profitability index of the product. In step 206 a statistical reliability of each measured profit impact and calculated profitability index is checked. For example if each of the product related advertisements has been offered in said theme more than 100 times and there is a clear indication as to which products are better profit makers than others, the profitability index distribution for said pool may be determined to be reliable. If there is not sufficient information on the profitability impact of a product related advertisement, the next product may be selected as shown in step 210. The selection may be made on a random, round robin or other basis, such as which products have undergone more testing. The measurement of profit impact, and profitability index and statistical reliability calculations may be performed by the feedback loop module 124.

If there is a clear indication as to which products are likely to generate most profit, those products may be first selected as in step 212. For example, products meeting or exceeding a profitability index threshold may be selected. The flow is continued in step 202 where the product most likely to provide profit is served. The profitability index for each product may be constantly maintained. For example, after each time the advertisement is served, profit impact may be measured and a new profitability index may be calculated, as shown in step 204. The calculation may take into consideration past profitability performance of the product. Since trends in consumer behavior may change performance, the profit impact can be weighted to take a time aspect into consideration, i.e. a lower weighting can be given to profit generated during a previous month as opposed to a previous week or previous hours or a previous minute. Depending on the weighting profitability, the profitability index can be tuned to take in consideration rapid changes in consumer behavior.

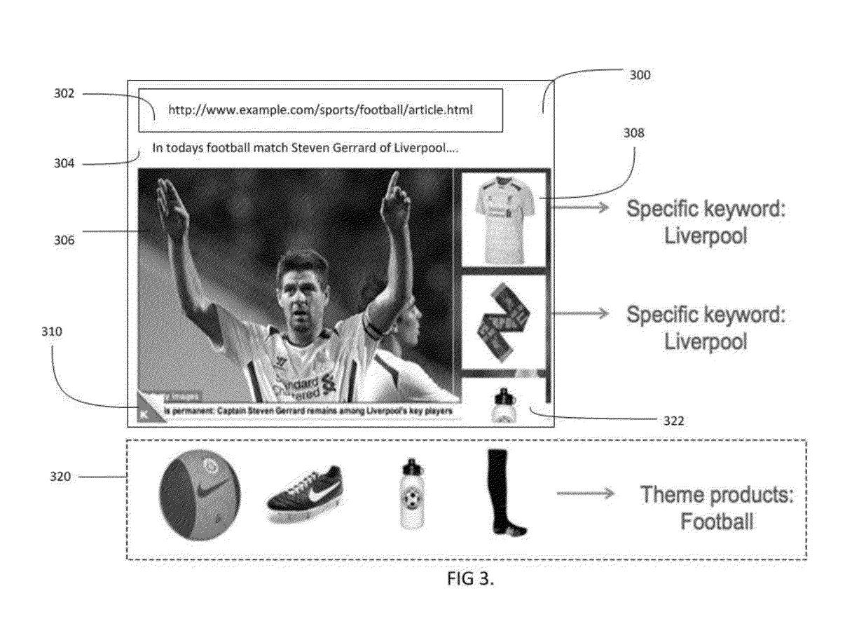

FIG. 3 shows a non-limiting example use case of intelligent matching of web site content to products for advertisement. A user with a user terminal 100 accesses a web service of a publisher. The browser view 300, in the current example, comprises text 304, an image 306, and a Uniform Resource Locator (URL) 302. In the example, a user has hovered with a mouse on top of the image 306 which has an indicator 310 to indicate that selecting the image might result in advertisement content being shown to the user. Hovering results in a request to show advertisement content. In prior art systems, advertisements are selected by analyzing keywords. In prior art examples, the found keyword “Liverpool” could mean either the city “Liverpool” or the football team “Liverpool”. From a product point of view, the same keyword would result in displaying different unrelated products. If the keyword is associated with the city, then advertisements could be, for example, related to travelling to Liverpool or, for example, real estate markets in the city of Liverpool. On the other hand, if the keyword is associated with the football team the advertised products may differ, and may include, for example, shoes for football, a ball, or Liverpool fan products. Keywords can be associated either manually or automatically.

In the present example, one or more themes of the currently accessed web page is defined. This can be done by analyzing, for example, one or more URL's or keywords, or a combination of URL's and keywords associated with the web page. In at least one embodiment, the interface module 120 may perform the analysis. For example, the URL of the accessed web page may be parsed to identify subjects, topics or themes of the web page. Furthermore, the URL may be analyzed to identify parent and child relationships within the URL to determine topics, themes, or sub-themes of the web page. In addition, themes can be fixed by the publisher i.e. the site map URL's can be associated with certain themes based on topics and other information. For example, URL's shown in a site map of a web site that includes the web page may include words designating subjects or words designating the content of each web page. As a result, the site map URL of the web page may be parsed to identify words indicating subjects related to content in the web page. Since the URL indicates/sport/the parent theme of the web page is determined to be “sports” and since the URL also indicates/football/, the child theme or sub theme of the web site is determined to be “football.” Further, in the page, a set of keywords are found that include “Liverpool.” As a result, a product pool 122 of the advertisement server 130 related to the theme category “Liverpool football theme” is selected for advertisement content, and a set of products in a pool associated with the theme “Football” 320 and a set of products belonging in the theme “Liverpool Football team” are considered as advertisement content. Products are selected either randomly from the pools 122 or are selected based on their profitability index. In an example, product 308 would come from the pool associated with “Liverpool Football Team” and products 322 from the pool associated with the theme “Football”.

An additional example related to FIG. 3 using intelligent matching of web site content to advertisements could include a web site divided into topics such as Sports, Entertainment and Technology. A web master may add a Sports script to the Sports section only (i.e. the set of URL's and related pages). Within Sports, there can be several themes such as Football, Rugby, Cricket and Boxing. Themes may be automatically identified by the system or may be manually assigned. Each theme may have specific assigned keywords, for example, related to persons or teams. If a keyword is identified, the script may add products from a pool related to the keyword by using the keyword as a search term. Otherwise, the script may add products from a general or “generic” theme pool at random.

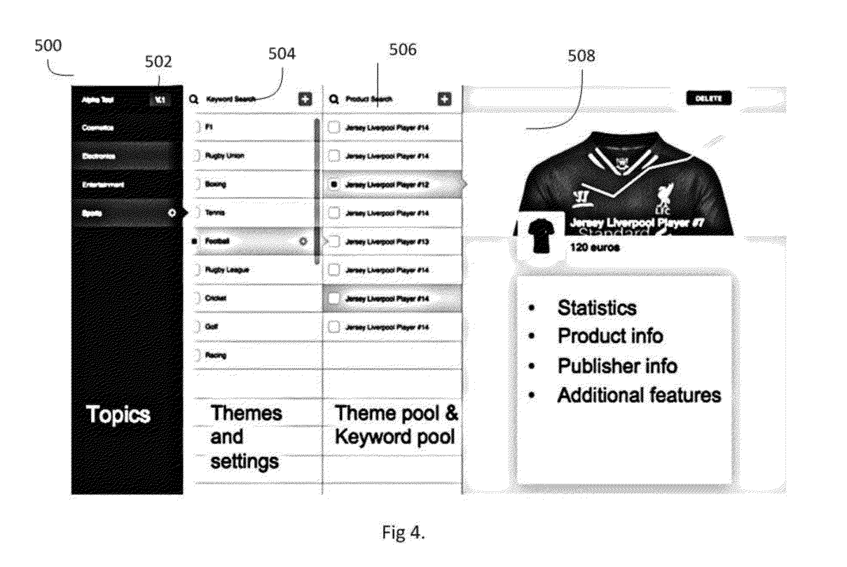

FIG. 4. shows an exemplary management interface 500 for managing themes within the advertising system 130. According to the present embodiments, a publisher, advertisement system provider or 3rd party may edit or manage themes and rules sets, 502 and may include selections for parent themes such as “Sports” or “Entertainment.” In the present example, “Sports” have been selected. The “Sports” theme has a sub theme or a set of keyword originated items 504 such as “Football” or “Tennis.” Under one sub theme 504 is shown a set of products 506 associated with the theme and sub theme (or keywords). For example, player shirts can be selected from the set of products. In the present example, a shirt designating player #12 is selected and shown in user interface 508 with a picture and other relevant information.

The management interface 500 can optionally be used for managing and editing disaster words, theme keywords, amounts of products, optimizing campaigns, analyzing results, designating product pools, adding themes, and topics. Certain keywords returned from a page may be designated “disaster words” which may block all product advertising when found. The campaign manager has an ability to edit a list of the disaster words. Examples of disaster words include “dead”, “riot”, “gun”. If an exemplary disaster keyword is found, for example, in a sports section/football the system can be configured not to provide any products. Theme keywords can have a unique theme keyword list. When identified, the theme keyword may be used for delivering products from the keyword pool. If not identified, a related theme pool is used instead. The campaign manager has an ability to edit this list. Amounts of products, the total amount of products returned and the keyword-products returned can be changed by the campaign manager in order to test for optimal amounts. When optimizing a campaign and analyzing results, the campaign manager may be provided with the ability to see the total impressions, engagements, clicks and revenue for each product in the keyword pool, the theme pool or both. The statistics may also show whether a product in the database 128 is out of stock or otherwise blocked, disabled in the pool, or assigned a lower score or a higher score. The campaign manager may use this information for editing the pools and keyword lists. Product pools, both the keyword pool and the theme pool may be provided with the same editing functionalities i.e. search for, add and disable products. In at least one embodiment, products are not removed, but are only disabled. Out-of-stock products may not be shown in the content. Themes can also be added by the campaign manager, for example, to accommodate changes in webpage design or demand. Each topic has different ways of identifying the themes and does not have to be added by the campaign manager. Topics are added by development.

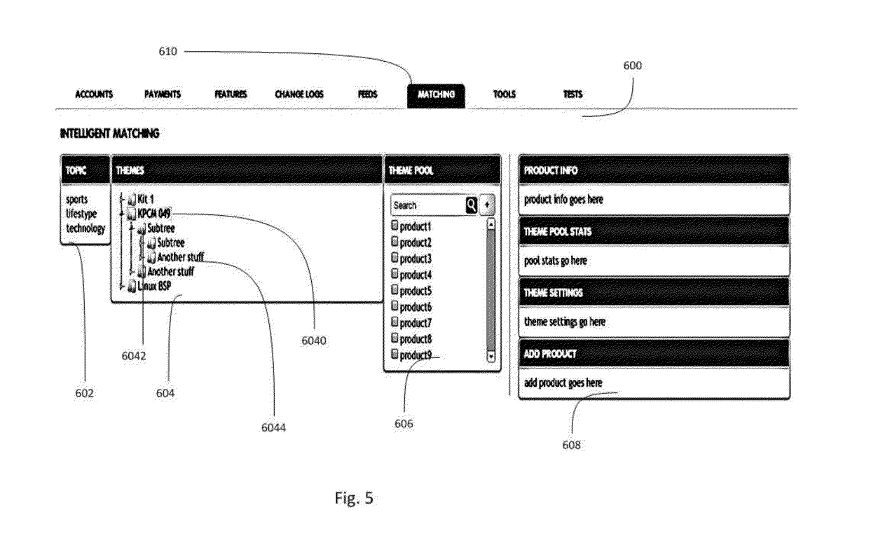

FIG. 5. illustrates another example of a user interface for managing themes and related products within the advertisement server 130. In this embodiment, a web interface 600, for example, a browser view of the management interface, has tabs for selecting functionality. A tab designated “matching” 610 is selected in this example. The user interface 600 enables the selection of a resulting topic 602 by, for example, a selection device such as a mouse or touch screen. Each topic has set of themes 604. Themes can be organized in a tree like matter with one or more parent themes 6040, sub themes 6042 for each parent theme 6040 and further sub themes 6044 for each sub theme 6042. There is no limitation on the number of layers or parallel themes. After selecting at least one theme and optionally one or more sub themes, a resulting theme pool of a set of products 606 associated with the selected theme and optionally selected sub themes is assembled. A user may be provided with the ability to add or delete products to or from the pool 606. A user may also be provided with the ability to view information 608 about one or more of the products in the pool 606.

The management interface 600 may optionally have the same functionality described for the management interface 500 including functionality related to topics, where topics may represent a first level category such as sports, fashion, etc. Topics may be predefined. In one example, the main content areas of a common news website may be classified as a topic, e.g. “Sports” or “Fashion”. In this embodiment, themes may represent a second level category. This example shows the themes within the sports topic, where exemplary themes include football, rugby, cricket, etc. Every theme belongs to one topic and may represent a major identifiable area of interest within the topic, e.g. for “Sports” themes include “Football” and “Tennis”. Themes may also include keywords, i.e. a word or a phrase which may be delimited by comma (‘,’) or newline character. Blocker keyword i.e. keyword which has undesired connotation such as police, killed, etc. The management interface 600 may have the same disaster word functionality as management interface 500. It should be understood that each product in theme product pool 606 may be linked to one or more themes. The management interface 600 may include a keyword product pool, i.e. a set of products which are used when any of keywords in the pool is matched. The management interface 600 may also provide publisher filtering, where a publisher can choose which keywords, brands, stores, or other entities to use as a whitelist or blacklist for product matching. In some embodiments, topics and themes may be the same for all publishers where a publisher selects at least one topic from a common list. In at least one embodiment, themes 600 may be automatically identified from the URL or page title. In one or more embodiments theme names can be different for different publishers. In some embodiments, profitability or other product related ratings may be determined from statistics per product for each pool and summed up n. Statistics may include a number of impressions, number of hovers, number of clicks, number of shares, and ratios such as: click/impression, click/hover, and sales(from affiliate reports)/click.

The matching logic may operate such that if multiple keywords match from different keyword pools under the same section, then only one keyword pool with the biggest total reported weight may be matched if the difference is significant, otherwise—a theme pool is presented. Keywords are assumed to be contradictory i.e. to conflict with each other, as in Barcelona and Liverpool keywords.

When analyzing the match statistics collected for monitoring and management reasons it would be helpful to know the match frequency data and reasons for decisions taken by matching. Information may be logged in the following cases to determine the match frequency data and the decision reasons (event—data logged): no theme identified—page URL, no keyword identified -page URL, stop keyword was identified—page URL, stop keyword, keyword was identified but no product was matched—keyword, multiple keywords were identified (conflict), having comparable weights (no clear winner)—keywords, decision made, no conflict, clear match—keyword, sectioned. Collected statistics should be reported by time periods (days, hours) both as number of times per event and per page URL(keyword). The analysis can be done continuously or based on predetermined engagement related milestones. The analytics output enables the content providers or advertisers to develop understandings regarding the topics, contents, or engagement regarding topics or contents that is of interest to users.

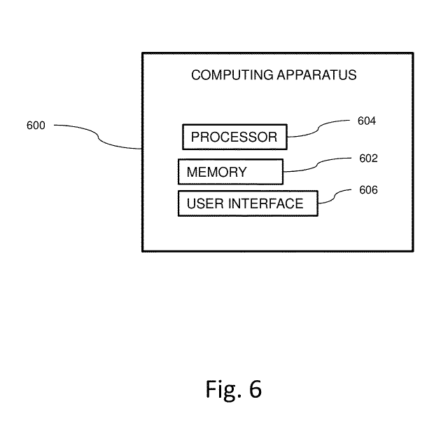

In at least one aspect of the disclosed embodiments, the techniques, methods and processes disclosed herein may be executed by one or more computers under the control of one or more programs stored on a non-transitory computer readable medium. FIG. 6 shows a block diagram of one embodiment of a computing apparatus 600 that may be used to implement the aspects of the present disclosure. In particular, the computing apparatus 600 can be used to implement one or more of the web terminal 100, web server 112, and computer system 130, including the modules implemented therein, of FIG. 1 for practicing aspects of the disclosed embodiments. The apparatus 600 may include, or be configured to execute, computer readable program code, or machine readable instructions, stored on at least one computer readable medium 602 for carrying out and executing the methods and process steps as are described herein

The computer readable medium 602 may be a memory of the computing apparatus 600. In alternate aspects, the computer readable program code may be stored in a memory external to, or remote from, the apparatus 600. The memory may include magnetic media, semiconductor media, optical media, or any media which is readable and executable by a computer. Computing apparatus 600 may also include a processor or controller, such as microprocessor 604, for executing the computer readable program code stored on the at least one computer readable medium 602. In at least one aspect, computing apparatus 600 may include one or more input or output devices, generally referred to as a user interface 606 which may operate to allow or receive input to the computing apparatus 600 or to provide output from the computing apparatus 600, respectively.

Embodiments of the present disclosure can be used for various purposes, including, though not limited to, enabling users to view relevant advertisements.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

1. A method of providing on line advertising comprising:
storing a database of products in an advertisement server, the products organized in a hierarchy of themes;
while using a terminal to access a web page, analyzing content of the web page to identify one or more themes of the web page; and
using an interface module of the advertisement server to retrieve advertisements from the database for products that have themes matching the web page themes.

2. The method of claim 1, wherein the products are assigned themes according to a product utilization measure.

3. The method of claim 2, wherein the product utilization measure is determined according to sales resulting from a product and theme combination.

4. The method of claim 1, wherein analyzing content of the web page comprises parsing a URL of the accessed web page for words designating a subject of the accessed web page.

5. The method of claim 1, wherein analyzing content of the web page comprises parsing a URL of the accessed web page to identify parent and child relationships within the URL to determine the one or more themes of the web page.

6. The method of claim 1, wherein analyzing content of the web page comprises parsing a URL of the web page specified in a site map for words designating content of the accessed web page.

7. The method of claim 1, comprising determining the profitability index from a number of times an advertisement is displayed.

8. The method of claim 1 comprising determining the profitability index from a number of times an advertisement is selected.

9. The method of claim 1 comprising determining the profitability index from actual sales resulting from advertising the product.

10. A system for presenting advertising comprising:
an advertisement server having a database of products organized in a hierarchy of themes;
an interface module web server configured to analyze content of a web page to identify one or more themes of the web page; and
a user terminal configured to access the web page and configured for presenting advertisements from the database that have themes matching the web page themes.

11. The system of claim 10, comprising a feedback module configured to assign themes to the products according to a product utilization measure.

12. The system of claim 11, wherein the product utilization measure is determined according to sales resulting from a product and theme combination.

13. The system of claim 10, wherein the interface module is configured to analyze content of the web page by parsing a URL of the accessed web page for words designating a subject of the accessed web page.

14. The system of claim 10, wherein the interface module is configured to analyze content of the web page by parsing a URL of the accessed web page to identify parent and child relationships within the URL to determine the one or more themes of the web page.

15. The system of claim 10, wherein the interface module is configured to analyze content of the web page by parsing a URL of the accessed web page specified in a site map for words designating content of the accessed web page.

16. A method of providing on line advertising comprising:
storing a database of products in an advertisement server, the products organized in a hierarchy of topics and themes within each topic, wherein the products are assigned themes according sales resulting from a product and theme combination;
using a feedback loop to determine a profitability index associated with each product;
while using a terminal to access a web page, analyzing content of the web page to identify a topic and theme of the web page; and
using an interface module of the advertisement server to retrieve advertisements from the database for products that have topics and themes matching the web page topics and themes and that meet a profitability index threshold.

17. The method of claim 16, wherein analyzing content of the web page comprises parsing a URL of the accessed web page to identify parent and child relationships within the URL to determine the topics and themes of the web page.

18. The method of claim 16, comprising determining the profitability index threshold from a number of times an advertisement is displayed.

19. The method of claim 16, comprising determining the profitability index from a number of times an advertisement is selected.

20. The method of claim 16, comprising determining the profitability index from actual sales resulting from advertising the product.
